(19) United States
(12) Patent Application Publication
(10) Pub. No.: US 2019/0077290 A1
(43) Pub. Date: Mar. 14, 2019

(54) Device For Holding Beverage Containers

(71) Applicant: Lightbulb Innovation, LLC, Lucas, TX (US)

(72) Inventors: Russell W. White, Austin, TX (US); Mordy D. Duke, Arcadia, OK (US); Shawn A. Roberts, Allen, TX (US)

(21) Appl. No.: 16/115,827

(22) Filed: Aug. 29, 2018

Related U.S. Application Data
(60) Provisional application No. 62/558,485, filed on Sep. 14, 2017.

(51) Int. Cl. B60N 3/10

(52) U.S. Cl. CPC B60N 3/10

(57) ABSTRACT

A system to hold a beverage container is disclosed. Such a system may include, for example, a platform having a top surface and a bottom surface. The platform may have a hole formed there through. As such, the platform may also define a vertical cross section through the diameter of the hole, and the cross section may have at least one chamfered corner. The hole may have a diameter between 2½ inches and 5½ inches. The system may also include a stretch fabric extending from the edge of the hole and beyond the bottom surface of the platform to form a generally cylindrical sleeve. The generally cylindrical sleeve may have an unstretched internal diameter that is less than the internal diameter of the hole.

This application claims priority to U.S. Provisional Patent Application No. 62/558,485, filed on Sep. 14, 2017, in the names of Russell W. White, Mordy D. Duke and Shawn A. Roberts, entitled “Device For Holding Beverage Containers,” the disclosure of which is hereby incorporated by reference.

### FIELD OF THE DISCLOSURE

The present disclosure relates to beverage containers and, more specifically, to a device for holding beverage containers.

### BACKGROUND

Beverage containers come in many different sizes and shapes. Beverages may be served in bottles, in cans, in plastic cups, in glasses, and in insulated containers just to name a few. Many of these containers are designed to be hand-held, but there are circumstances that make holding a container with one's hand difficult or dangerous. For example, it is dangerous for a person to hold a cup, can, or bottle while driving or boating. Similarly, it is difficult to hold a beverage container while swimming or lounging in water. Aquatic activities are frequently enjoyed in bodies of water like swimming pools and lakes, and it is common for a person to want a beverage while they are enjoying the aquatic activity. Like driving or boating, the beverage containers available to a person enjoying the water can come in many sizes and shapes.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a general system for holding a beverage container that incorporates teachings of the present disclosure;

FIG. 2 illustrates a given embodiment of a device for holding beverage containers of varying sizes that incorporates teachings of the present disclosure;

FIG. 3 illustrates a cut away view of a system for holding a beverage container that incorporates teachings of the present disclosure;

FIG. 4 illustrates example cross sections of a portion of a system for holding beverage containers that incorporate teachings of the present disclosure;

FIG. 5 illustrates a tray-based embodiment of a device for holding beverage containers of varying sizes that incorporates teachings of the present disclosure; and

FIG. 6 illustrates a modular embodiment of a device for holding beverage containers of varying sizes that incorporates teachings of the present disclosure.

### DETAILED DESCRIPTION

The following discussion is intended to provide one skilled in the art with various teachings that can be combined and/or separated to create useful and/or desirable products. The teachings can be employed in a variety of settings. For example, a designer could use these teachings to create an automobile-oriented, boat-oriented, and/or other vehicle-oriented product that provides a near universal “cup holder.” In another example, a designer may want to employ many of these teachings to produce a fold-down food tray product similar to the ones found in the back of a typical airplane seat. By adding a holder for beverage containers that incorporates teachings of the present disclosure, a designer may help passengers manage drinks on a flight that may be experiencing turbulence.

While there are many opportunities for designers to use the teachings disclosed herein, the majority of this detailed description section will focus on embodiments designed for aquatic activities. The decision to focus on pool and lake settings is not intended to limit the scope of the teachings, but rather to facilitate a clear presentation of the teachings.

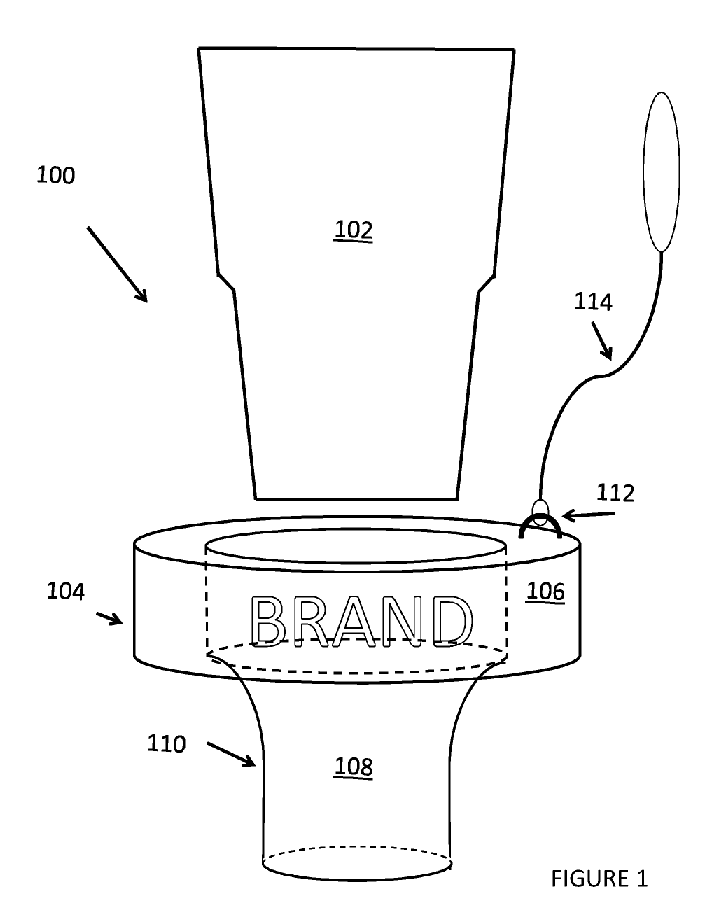

With that said and as mentioned above, FIG. 1 depicts a general system 100 for holding a beverage container 102 that incorporates teachings of the present disclosure. As depicted, beverage container 102 may be a double-walled insulated cup (like a Yeti Rambler or RTIC Tumbler). In one embodiment, system 100 is designed to include a near-universal holder 104 that can effectively hold many different sizes and types of containers. To accomplish this goal, holder 104 may include a flotation ring 106 with an internal diameter between approximately 2½ inches and 5½ inches and a 4-way stretch fabric sleeve 108 encasing the flotation ring and extending beyond the bottom surface to form a generally cylindrical sleeve. The generally cylindrical sleeve may have an unstretched internal diameter that is less than the internal diameter of flotation ring 106. For example, the unstretched diameter of sleeve 108 may be approximately 1½ inches. The relatively large opening in ring 106 coupled with the relatively small unstretched opening in sleeve 108 may allow system 104 to effectively hold many different sizes of beverage containers.

In the depicted embodiment, the stretch fabric that forms sleeve 108 extends around and encases ring 106. A designer may choose to eschew the encasing quality of the sleeve and simply attach a top portion of the sleeve to the ring using adhesives, a snap in groove and ring connection, and/or any other appropriate connection technique. Depending on design concerns, the stretch fabric may be a synthetic fabric that stretches. The stretch fabric may be a multi-way stretch fabric such as 2-way stretch or 4-way stretch. An exemplary 2-way stretch fabric may stretch in one direction, such as from selvedge to selvedge (but can be in other directions depending on the knit). An exemplary 4-way stretch fabric, such as spandex, may stretch in both directions, crosswise and lengthwise. A given stretch fabric may include fibers of neoprene. Example stretch fabrics could include elastomerics like spandex or Lycra. With that said, a designer could choose whichever stretch fabric he or she wanted to accomplish a given deign goal.

As shown in FIG. 1, holder 104 may also include a branding location 110 where a designer may print, embroider, or otherwise provide a brand like “YETI” or some other name, slogan, image, etc. In one embodiment, a designer may elect to package multiple holders, like holder 104, in a given package. The multiple holders may be differentiated from one another, for example, by color or the text/image placed in branding location 110. Providing multiple but differentiated holders may allow several people to lounge in a pool without losing track of which beverage container belongs to which person.

Similarly, system 104 may also include a leash attachment location 112 and a leash 114. As depicted, leash 114 is a removable component of system 104. As such, leash attachment location 112 may include several different types of connector types. For example, location 112 may include one half of a Velcro or hook and loop type connector while leash 114 may include the other half. The connection type might be carabineer-like, claw-like clasp, overlapping metal ring, etc. Making leash 114 removable may provide a better experience for users. In circumstances where a leash is unnecessary, it may be removed, which could provide a safer experience. An unused leash dangling from system 104 could get caught in drains, around legs, around necks, etc.

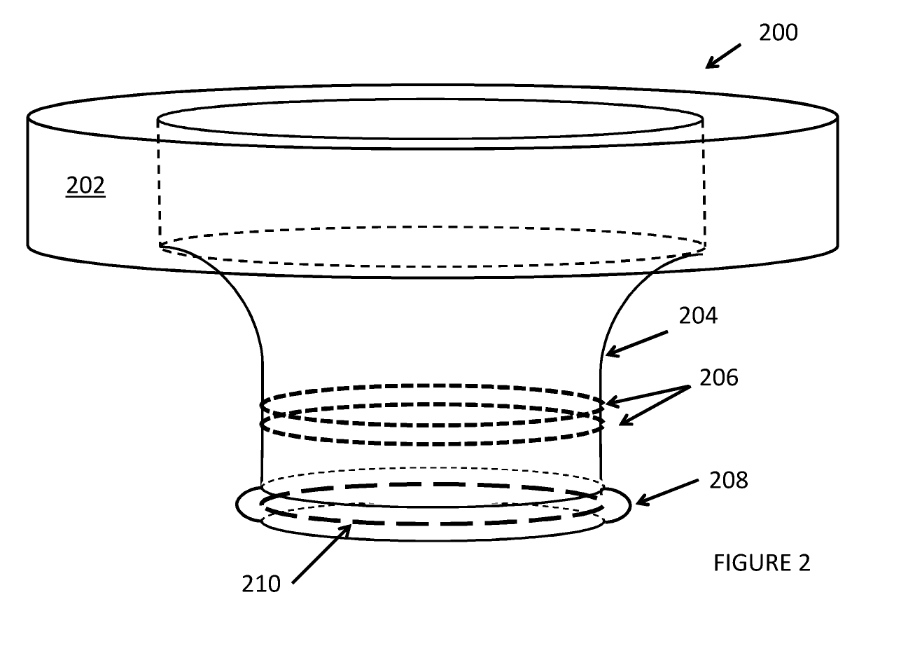

As indicated above, FIG. 2 illustrates a given embodiment of a device 200 for holding beverage containers of varying sizes that incorporates teachings of the present disclosure. As shown, a flotation ring 202 is wrapped by a stretch fabric sleeve 204. In the depicted embodiment, sleeve 204 includes two gripper elements 206 attached to sleeve 204. As depicted, elements 206 may be rubberized rings that provide additional grip as compared to the material of sleeve 204. Elements 206 may be attached to sleeve 204 in a number of ways. For example, elements 206 may be sewn into sleeve 204 and/or glued to sleeve 204. As depicted, elements 206 are not uniform along their length. The “breaks” along the rubberized elements may help ensure that elements 206 do not unduly limit the stretch fabric of sleeve 204 from stretching to accommodate beverage containers of various sizes.

FIG. 2 also includes a pocket 208 formed from the stretch material of sleeve 204. As shown, weighted material 210 has been inserted within pocket 208. Weighted material 210 may help stabilize system 200 when it is deployed in a pool or lake. And, as with the “breaks” along elements 206, the “breaks” in weighted material 210 may help to keep weighted material 210 from unduly limiting the stretchability of sleeve 204. One skilled in the art will recognize that the depiction in FIG. 2 teaches the potential benefits of adding a weight “beneath” ring 202. The manner in which the weight is suspended beneath a flotation ring may be changed depending upon design concerns.

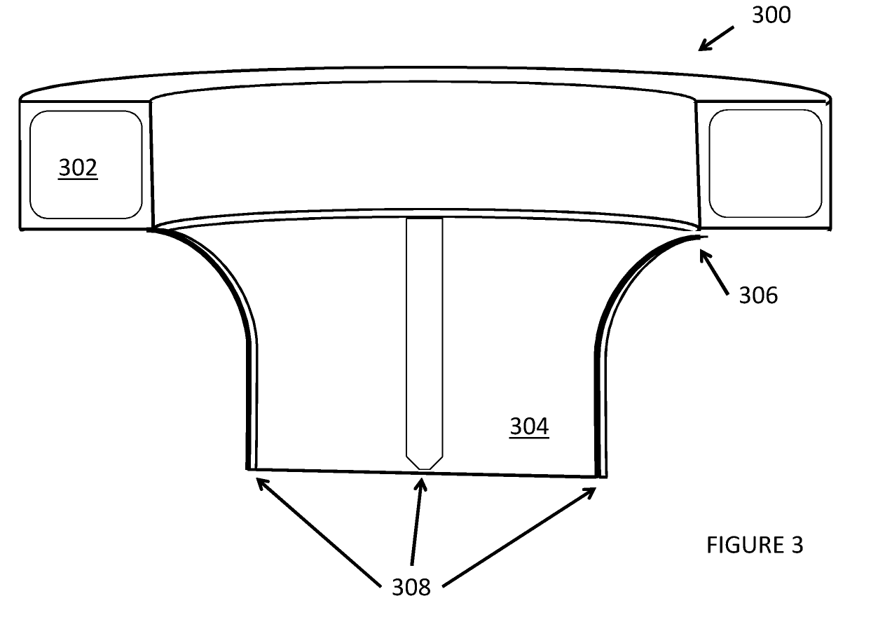

As mentioned above, FIG. 3 illustrates a cut away view of a system 300 for holding a beverage container that incorporates teachings of the present disclosure. As shown, a flotation ring 302 is encased within a stretch fabric that ultimately forms a compression sleeve 304 extending “beneath” ring 302. As shown, the stretch fabric is connected at seam 306 to form a pocket within which ring 302 rests. FIG. 3 also depicts stiffening fingers 308. As shown, stiffening fingers 308 may be sewn into or attached to sleeve 304 to provide additional “holding” strength for a beverage container inserted into system 300. Fingers 308 could be plastic, rubber, or any other suitable material. They may be attached to system 300 via sleeve 304. They may also be part of ring 302 or added in any manner a designer prefers. Moreover, referring to them as fingers does not rule out the use of protrusions having various sizes and shapes. Referring back to seam 306 as well as fingers 308, the manner of connecting the stretch fabric to itself and/or other components may be, for example, a sewn seam, a glued seam, a heat-sealed seam, etc.

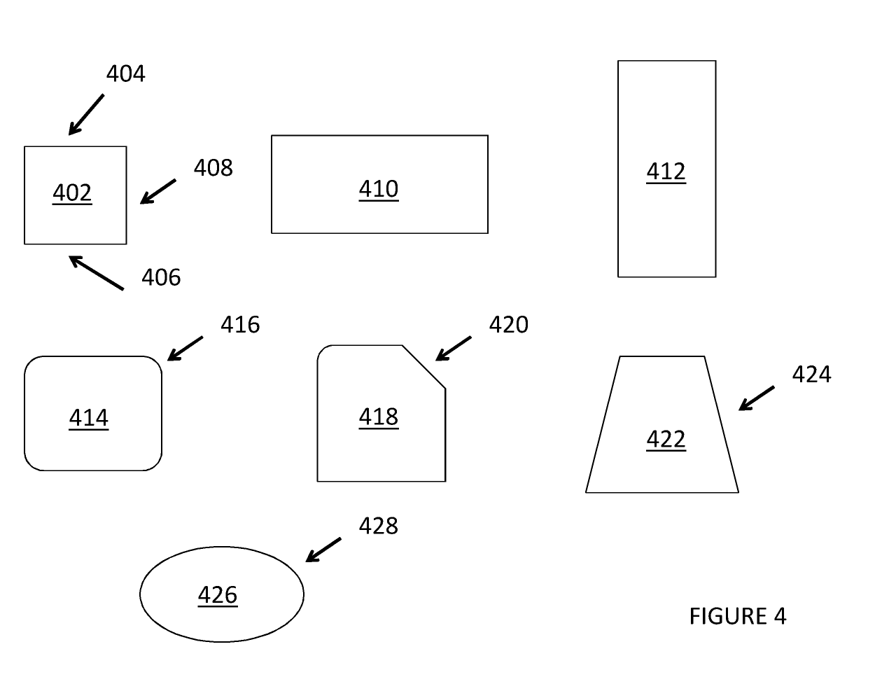

FIG. 4 illustrates example cross sections of a portion of a system for holding beverage containers that incorporate teachings of the present disclosure. In one embodiment, the various cross sections may be cross sections of a flotation ring like ring 302. In practice, the rings could be formed from a single material or a combination of materials. For example, a ring may be a composite of a buoyant and relatively brittle material and a more rigid material. The ring could include one or more types of foam. The ring could be formed to define an internal void that provides the majority of the buoyancy. A designer could choose from several different types and/or combinations of materials.

As shown, cross section 402 is generally square in shape with a “top” surface 404 and a “bottom” surface 406. The top and bottom may change depending upon how a given holder system like system 200 is placed in the water. As shown, cross section 402 also has a container-facing edge 408. With regard to cross section 402, the width dimension of the cross section may be equal to the height dimension. This may not always be true for other cross sections. For example, cross section 410 has a width dimension that is larger than its height dimension. Conversely, cross section 412 has a width dimension that is smaller than its height dimension. A designer may choose a given cross section for his or her needs. For example, a designer may choose a cross section (like cross section 410) with a larger width dimension to help stop splash over. In a pool or lake setting there may be wave action that causes water to splash over the flotation ring. If the flotation ring has a cross section with a width dimension that is sufficiently large to create an overall outside diameter of the flotation ring in excess of 5 inches, the ring may help stop splashing water from getting into a beverage container being held in a system like system 200. Wider outside diameters for a given flotation ring may be preferred by some designers. In some case, a designer may choose a flotation ring with an outside diameter of over 6 inches, over 7 inches, over 8 inches, over 9 inches, etc. The increasing sizes may provide more stability and splash protection. At this point, it should be noted that a designer may not want a circular outside or inside edge for his or her flotation ring. For example, a designer may want the outside edge to resemble a flower, an animal, a non-circular shape, etc. Similarly, a designer may want the inside edge to be scalloped or formed to provide stiffening fingers as discussed above.

In some cases, a designer may prefer a relatively large height dimension for various reasons like providing a potentially larger surface area of contact between the ring and the beverage container being held. As shown, cross-section 414 may include a rounder chamfer 416, which may make it easier to load a beverage container into a system like system 200. As shown, cross section 414 includes a curved chamfer at all four corners. Cross section 418, on the other hand, includes a straight-line chamfer 420 at the “top” of its internal edge. Unlike the chamfer of cross section 418 (which only extends part way down), cross section 422 includes a chamfer 424 that extends from the “top” surface to the “bottom” surface. While cross sections 402, 410, 412, 414, 418, and 422 are generally quadrilaterals, other shapes could be employed. For example, cross section 426 is generally elliptical. As such, it has curved chamfers 428 at all four “corners.”

The above discussion focuses on floating and near-universal beverage holders. One skilled in the art will recognize that the materials chosen to create a given system may be chosen to help ensure a resistance to sun fading, mildewing, and heat and water based degradation. A designer will also recognize that the teachings have far reaching applicability. For example, the flotation ring may be “replaced” with the food tray of an airplane, the cup holder region of an automobile, boat, and/or other vehicle and the stretch fabric sleeve may connect to and extend from the internal diameter of a hole cut in the tray and/or cup holder. By way of example, a stretch fabric sleeve may be connected to a ring that can replace and/or be retrofit into a cup holder location of a vehicle. It may also snap into an existing cup holder, which may obviate removal of the existing cup holder.

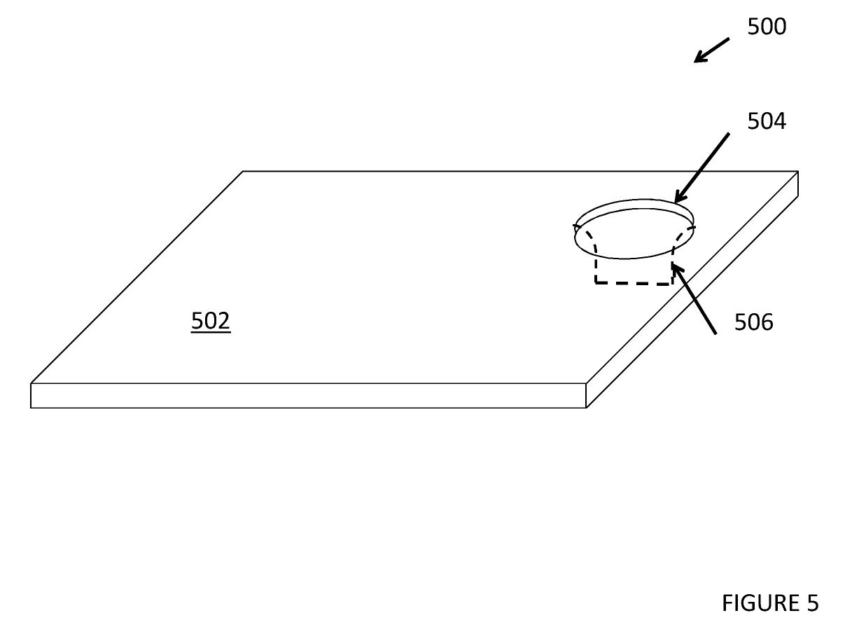

FIG. 5 illustrates a tray-based embodiment of a system 500 for holding beverage containers of varying sizes that incorporates teachings of the present disclosure. As shown, a hole 504 is formed through a platform 502. Platform 502 could be, for example, an airplane tray table, an automobile console element, a portion of a boat, or some other appropriate location. As depicted, platform 502 has a top surface and a bottom surface. The platform 502 has a hole 504 formed there through. As depicted, platform 502 defines a vertical cross section through the diameter of the hole, and that cross section may have at least one chamfered corner. Hole 504 may have a diameter between approximately 2½ inches and 5½ inches. The system may also include a stretch fabric sleeve 506 extending from the edge of hole 504 and beyond the bottom surface of platform 502 that forms a generally cylindrical shape. The generally cylindrical sleeve 506 may have an unstretched internal diameter that is less than the internal diameter of the hole. In some embodiments, sleeve 506 may be tapered to form a generally conical shape that provides a progressively tightening sleeve. The tapering may be accomplished, for example, by combining multiple sleeve pieces having different unstretched internal diameters into a single sleeve. Such a design could help “hold” a cup, bottle, etc. in place during turbulent flight. As with all the teachings of this disclosure, the tapering teaching may be applied to any of the systems discussed herein.

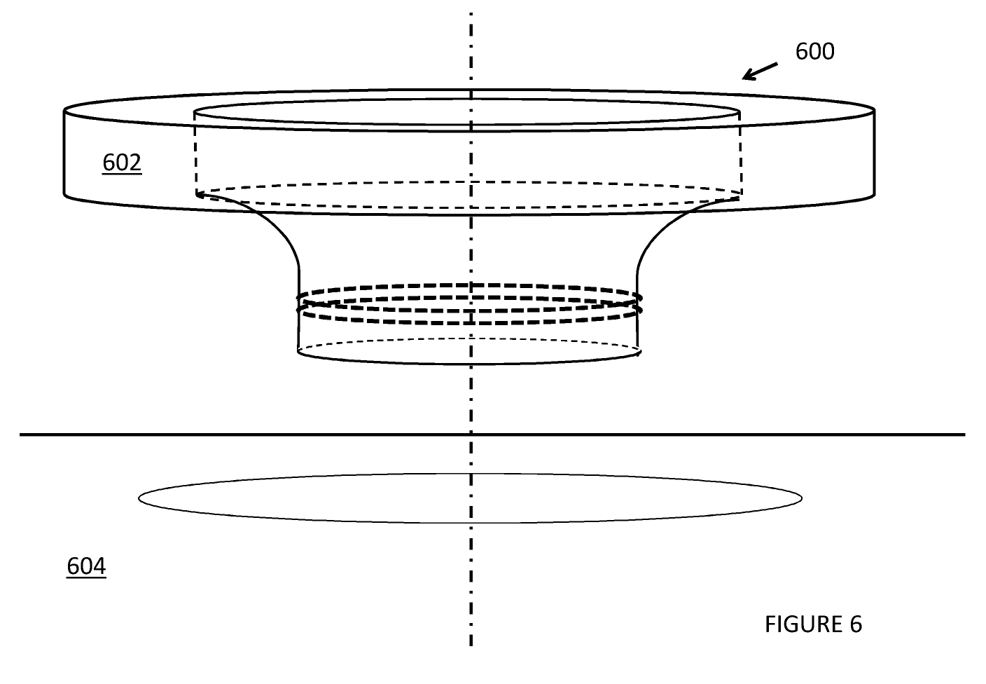

As mentioned above, FIG. 6 illustrates a modular embodiment 600 of a device 602 for holding beverage containers of varying sizes that incorporates teachings of the present disclosure. Such a system may be incorporated, for example, in a vehicle (e.g., boat, ATV, automobile, etc.). As such, the flotation ring of systems like system 300 may be “replaced” by a console 604 and the stretch fabric sleeve may connect to and extend from the internal diameter of a hole cut in console 604. Such a design could help “hold” cups, bottles, etc. of various sizes in place during operation of the vehicle. Many users find that the cup holders of vehicles are often too large for many beverage containers. The designer of a traditional cup holder may make it large enough to hold a very big cup without realizing that such a design often creates a “hole” that is too big for a bottle of water or a thinner canned beverage. Utilizing the teachings of this disclosure may assist in reducing the negative impact of this design choice. And in some embodiments, device 602 may be modular and designed as a replacement and/or insertable enhancement to an existing cup holder.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system to hold a beverage container, comprising:
a generally washer-shaped ring having a top surface, a bottom surface, a thickness, and a hole formed through the ring;
the hole defining an opening with a cross sectional area at its widest point between 5 square inches and 20 square inches;
a 4-way stretch fabric coupled to the ring and continuing beyond the bottom surface of the ring to form a tapering sleeve, wherein the tapering sleeve has an unstretched internal cross sectional area at its narrowest point that is less than 3.5 square inches; and
a mounting mechanism configured to couple the generally washer-shaped ring to a cup holder location of a vehicle.

2. The system of claim 1, further comprising an extending portion of the ring that extends downwardly from the bottom surface along the opening.

3. The system of claim 1, wherein the stretch fabric comprises an elastomeric.

4. The system of claim 1, wherein the mounting mechanism comprises a groove that facilitates a snap-in mounting at the cup holder location of the vehicle.

5. The system of claim 2, wherein the extending portion comprises more than one extending finger that extends downwardly from the bottom surface and inwardly toward a center point of the hole such that the more than one extending finger provides a compressing force on an object inserted through the hole and into the tapering sleeve, further wherein the 4-way stretch fabric couples to the extending portion via at least one of an encasing of the ring, an adhesive, and grove formed in the extending portion.

6. The system of claim 2, wherein the generally washer-shaped ring and the extending portion are formed as a unitary component.

7. The system of claim 6, wherein the generally washer-shaped ring and the extending portion comprise plastic.

8. The system of claim 1, wherein the hole and the opening are generally circular in shape.

9. The system of claim 1, wherein the vehicle is selected from a group consisting of a boat, an automobile, and an airplane.

10. A system to hold a beverage container, comprising:
a ring component of a cup holder having a top surface and a bottom surface, wherein the ring component has an internal diameter between 2½ inches and 5½ inches and an external diameter greater than 3½ inches;
a 4-way stretch fabric extending beyond the bottom surface to form a tapering cylindrical sleeve, wherein the tapering cylindrical sleeve has an unstretched internal diameter at its narrowest point that is less than 2 inches; and
a gripping component incorporated within the tapering cylinder sleeve.

11. The system of claim 10, wherein the ring component is at least partially formed from a material having a specific gravity that is less than 1.0.

12. The system of claim 10, further comprising a plurality of fingers extending along the tapering sleeve and configured to provide a compression force against an object inserted into the tapering sleeve.

13. A system to hold a beverage container, comprising:
a replacement cup holder ring with a hole formed through it, the hole defining an opening with a cross sectional area larger than 7 square inches; and
a 4-way stretch fabric formed into a tapering cylindrical sleeve, wherein a first end of the tapering cylindrical sleeve is open and coupled to the replacement cup holder ring, further wherein the tapering cylindrical sleeve has an unstretched internal cross sectional area at its narrowest point that is less than 5 square inches.

14. The system of claim 13, wherein the tapering cylindrical sleeve is removably coupled to the replacement cup holder ring.

15. The system of claim 13, wherein the 4-way stretch fabric is configured to provide a compressive force on a beverage container placed through the replacement cup holder ring and into the tapering cylindrical sleeve.

16. The system of claim 15, further comprising a gripping element coupled to the 4-way stretch fabric.

17. The system of claim 13, wherein a second end of the tapering cylindrical sleeve is also open.

18. The system of claim 13, wherein the replacement cup holder ring is formed from a plastic material.

19. The system of claim 15, wherein a top surface of the replacement cup holder ring has a chamfered edge around the hole that facilitates a placing of the beverage container through the replacement cup holder ring and into the tapering cylindrical sleeve.

20. The system of claim 15, wherein a top surface of the replacement cup holder ring comprises a branding location.
